(19) United States
(12) Patent Application Publication
(10) Pub. No.: US 2012/0313819 A1
(43) Pub. Date: Dec. 13, 2012

(54) Active Antenna and Electronic Device

(76) Inventors: Chia-Tien Li, Hsinchu (TW); Li-Jean Yen, Hsinchu (TW)

(21) Appl. No.: 13/236,652

(22) Filed: Sep. 20, 2011

(30) Foreign Application Priority Data
Jun. 13, 2011 (TW) 100120543

(51) Int. Cl. H01Q 3/12

(52) U.S. Cl. 342/374

(57) ABSTRACT

An active antenna with a wide bandwidth coverage is disclosed. The active antenna comprises a radiator, comprising at least two feeding points corresponding to two modes, a switch control circuit, for generating a switch control signal, and an active switch circuit, for switching to be coupled to one of the at least two feeding points.

### BACKGROUND OF THE INVENTION

1. Field of the Invention

The present invention relates to an active antenna and electronic device, and more particularly, to an active antenna and electronic device having a wide range of operation bandwidth and a compact size.

2. Description of the Prior Art

With the advancement of recent wireless communication technologies, demand for wireless communication has surged, and an increasing amount of information is now transmitted wirelessly, resulting in higher bandwidth requirements. Light-weight, small form factor, and compactness have also become design criteria for communication devices.

Generally, a conventional mobile electronic device utilizes a passive antenna. More recent designs have also resorted to utilizing an active switch circuit with an antenna due to shortage of space, so as to improve utilization of space and communication quality. For example, a conventional mobile phone maybe equipped with an antenna switch circuit with multiple antennas for wireless reception/transmission (i.e. multiple radiators), and automatically select between an antenna with a wider receiving bandwidth coverage during stand-by, and another antenna with higher radiation efficiency during calls.

However, such conventional method of switching between multiple antennas for transmission and reception incurs higher costs and larger dimensions, and often employs a single-plane architecture, which leads to limited utilizable space and reduces design flexibility. Hence, it is necessary to improve over the prior art.

### SUMMARY OF THE INVENTION

Therefore, a primary objective of the invention is to provide an active antenna and electronic device with wide bandwidth coverage and small dimensions.

The invention discloses an active antenna with a wide bandwidth coverage. The active antenna comprises a radiator, comprising at least two feeding points, corresponding to at least two modes, respectively; a switch control circuit, for generating a switch control signal; and an active switch circuit, for switching to be coupled to one of the at least two feeding points according to the switch control signal .

The invention further discloses an electronic device. The electronic device comprises a radio-frequency processing unit, for processing a radio-frequency signal; and an active antenna with a wide bandwidth coverage, comprising a radiator, comprising at least two feeding points corresponding to at least two modes, respectively; a switch control circuit, for generating a switch control signal; and an active switch circuit, for switching to be coupled to the one of the at least two feeding points according to the switch control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an active antenna according to an embodiment of the invention.

FIG. 2A is a schematic diagram of a return loss of the active antenna shown in FIG. 1 when an active switch circuit is coupled to different feeding points, respectively.

FIG. 2B is a schematic diagram of an antenna radiation efficiency of the active antenna shown in FIG. 1 when the active switch circuit is coupled to the different feeding points, respectively.

FIGS. 3A and 3B are schematic diagrams of a preferred return loss and a preferred antenna radiation efficiency of the active antenna shown in FIG. 1, respectively.

### DETAILED DESCRIPTION

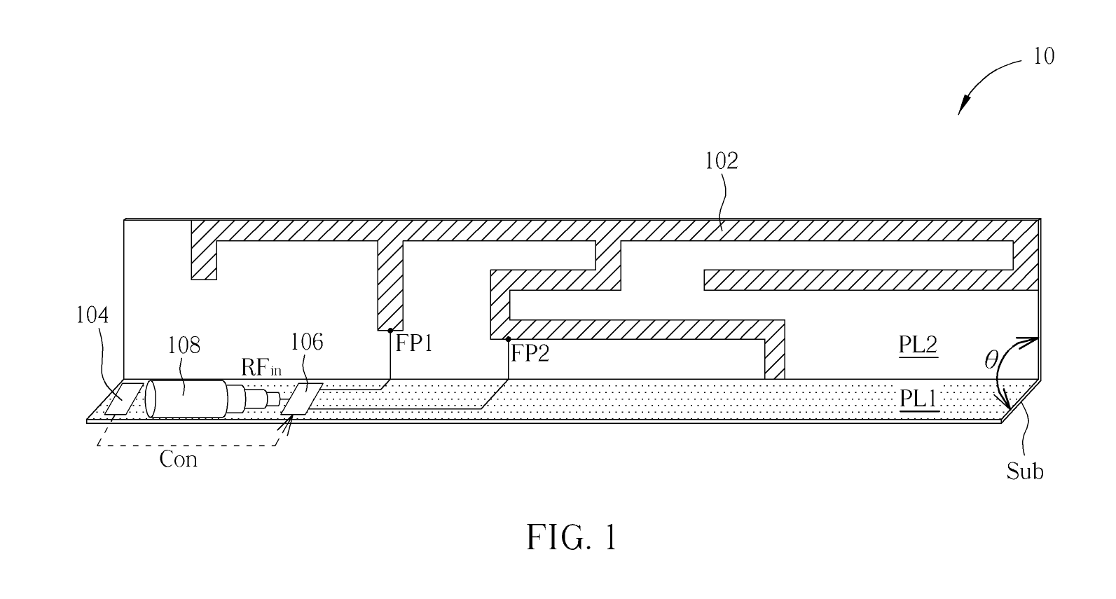

Please refer to FIG. 1, which is a schematic diagram of an active antenna 10 according to an embodiment of the invention. As shown in FIG. 1, the active antenna 10 includes a radiator 102 (hatched area), a switch control circuit 104, an active switch circuit 106, and a signal feeding terminal 108. In short, the radiator 102 includes feeding points FP1, FP2 corresponding to two modes, respectively. The switch control circuit 104 generates a switch control signal Con to the active switch circuit 106, such that the active switch circuit 106 switches between being coupled to one of the feeding points FP1, FP2 according to the switch control signal Con, to operate the radiator 102 in one of the two modes. As such, the active antenna 10 can operate in different modes via switching between being coupled to different feeding points of the radiator 102, to obtain a wider operation bandwidth.

In more detail, when transmitting a signal, the switch control circuit 104 controls the active switch circuit 106 to be coupled to one of the feeding points FP1, FP2 according to a communication status, such that the signal feeding terminal 108 can feed a radio-frequency signal RFin into one of the feeding points FP1, FP2 via the active switch circuit 106, and then transmit the radio-frequency signal RFin via different antenna paths of the radiator 102. In other words, since when the radio-frequency signal RFin is fed at different feeding points, antenna paths of the radio-frequency signal RFin in the radiator 102 are also different, the radiator 102 can operate in different modes. Therefore, resonance frequency of the radiator 102 changes or shifts accordingly. Similarly, when receiving the signal, the switch control circuit 104 can also control the active switch circuit 106 to be coupled to one of the feeding points FP1, FP2 according to the communication status, to operate in a suitable mode. As such, the switch control circuit 104 controls the active switch circuit 106 to be coupled to a suitable feeding point in the radiator 102 according to the communication status, to increase the operation bandwidth of the antenna and enhance communication quality.

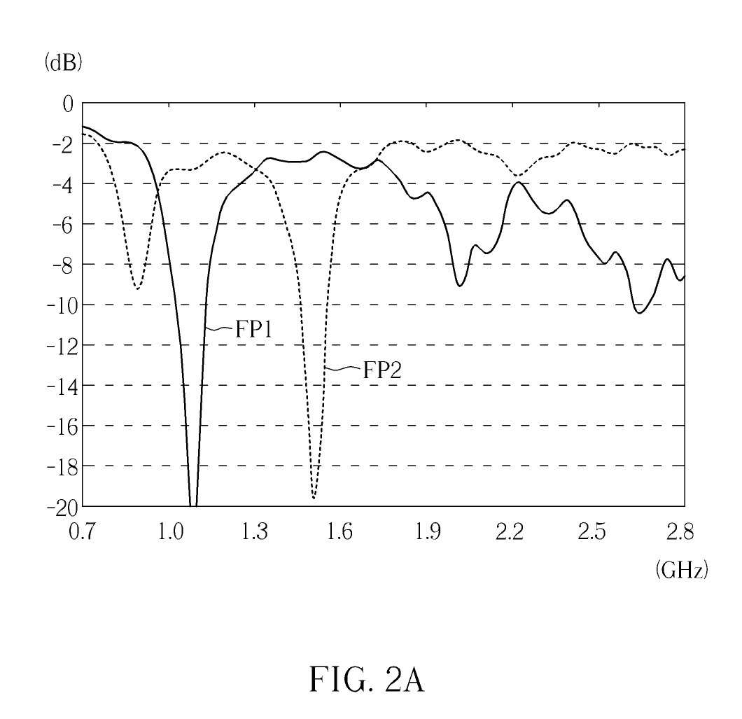

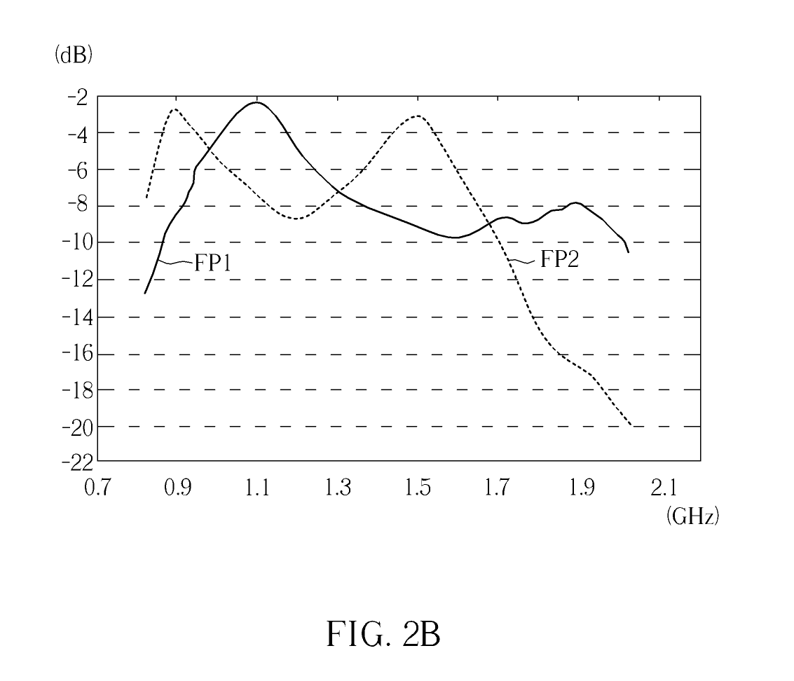

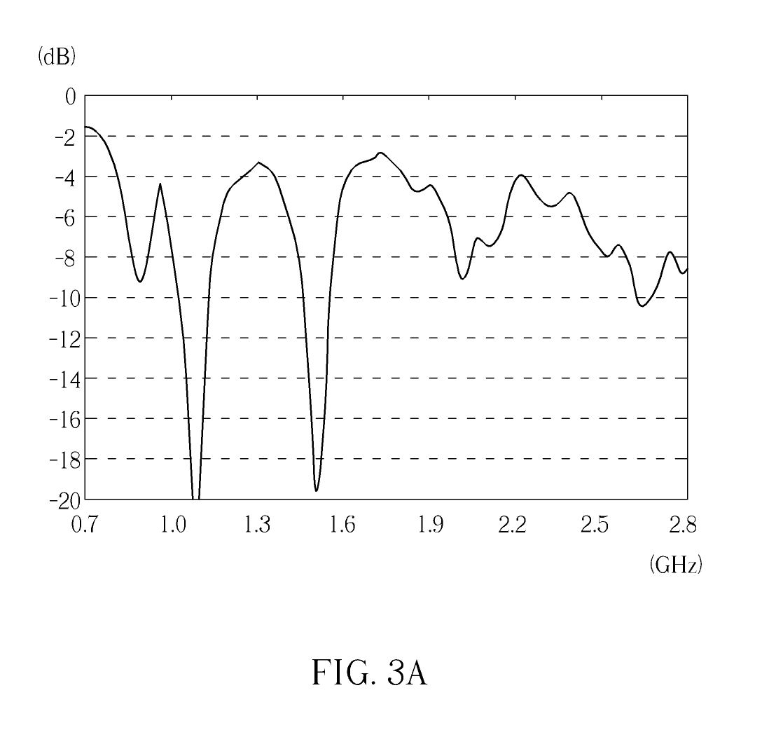

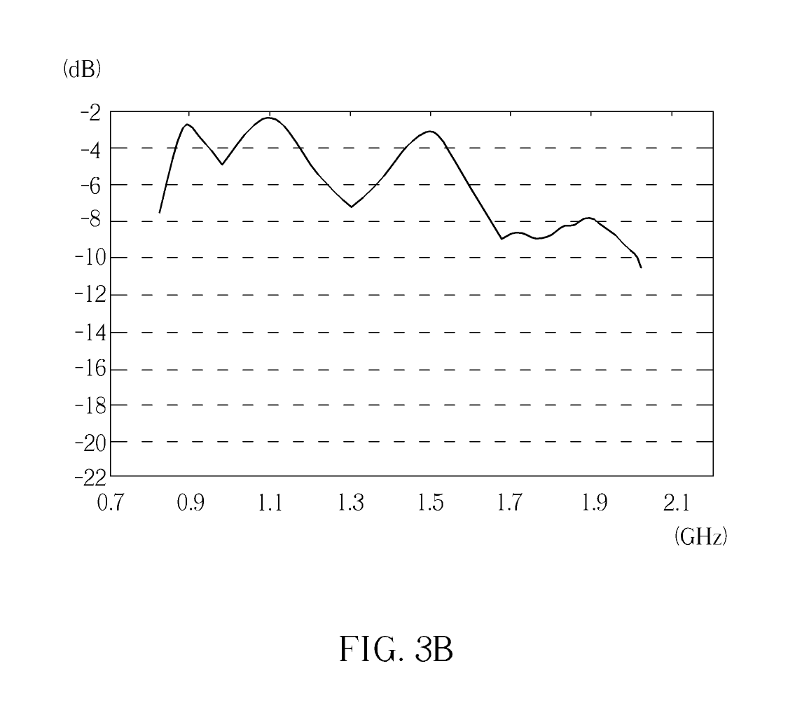

Specifically, please refer to FIGS. 2A and 2B. FIG. 2A is a schematic diagram of a return loss of the active antenna 10 when the active switch circuit 106 is coupled to the feeding points FP1, FP2, respectively. FIG. 2B is a schematic diagram of an antenna radiation efficiency of the active antenna 10 when the active switch circuit 106 is coupled to the feeding points FP1, FP2, respectively. As shown in FIGS. 2A and 2B, when the active switch circuit 106 is coupled to the feeding points FP1, FP2, the active antenna 10 operates in two corresponding modes, respectively. The return loss and antenna radiation efficiency of the active antenna 10 under the two different modes are represented by solid and dotted lines, respectively. As such, as shown in FIGS. 3A and 3B, under a preferred condition when the switch control circuit 104 controls the active switch circuit 106 to be coupled to a suitable feeding point of the feeding points FP1, FP2 according to the communication status, the active antenna 10 is capable of operating with a lower return loss and higher antenna radiation efficiency in the two modes, to increase antenna operation bandwidth and enhance communication quality.

On the other hand, please continue to refer to FIG. 1. As shown in FIG. 1, an extension plane PL1 of the active switch circuit 106 and an extension plane PL2 of the radiator 102 preferably have an angle e from each other. The angle e may be 90° (i.e. the planes PL1, PL2 are perpendicular to each other), or any other specific angles (i.e. the active antenna 10 is a three-dimensional structure). In such a case, an antenna ground plane of the radiator 102 and an extension plane PL1 of the active switch circuit 106 may be disposed on a substrate Sub, as shown in FIG. 1. Alternatively, the antenna ground plane of the radiator 102 may be parallel to the extension plane PL1 of the active switch circuit 106 (not shown), or be an extension of a ground plane of the active switch circuit 106 (not shown). As such, since the active antenna 10 utilizes a three-dimensional structure to implement the antenna (i.e. the radiator 102) and the active switch circuit 106, it is possible to achieve higher space utilization, therefore allowing smaller dimensions.

Note that, the spirit of the present invention is that the active antenna 10 may operate in different modes via switching to be coupled to different feeding points of the radiator 102, to obtain a wider operation bandwidth. Also, the three-dimensional structure of the radiator 102 allows effective space utilization, and thus smaller dimensions. Additionally, modifications or variations may be made accordingly by those skilled in the art, and are not limited thereto. For example, the embodiment in FIG. 1 is characterized by switching between different feeding points of the radiator 102, and utilizing a three-dimensional structure. However, the two above features may also be implemented separately, without losing their respective advantages. Moreover, FIG. 1 only shows two feeding points FP1, FP2 corresponding to two modes, respectively. In reality, the active switch circuit 106 may switch between one of more than two feeding points, such that the radiator 102 can operate in one of more than two modes. Furthermore, the design of the radiator 102 can have different structures according to requirements, and is not limited to the structure as shown in FIG. 1.

On the other hand, signal feeding terminal 108 is preferably a coaxial cable signal feeding terminal, i.e. the active antenna 10 is applied to mobile electronic devices such as notebook computers, tablet computers, mobile phones or electronic books, but can also be applied to other electronic devices, providing that the electronic devices include a radio-frequency processing unit for transmitting or receiving radio-frequency signals. Moreover, the switch control circuit 104 can be a voltage control circuit, utilizing the switch control signal Con with different control voltages, to switch the active switch circuit 106 to be coupled to different feeding points, but not limited thereto. Furthermore, dimensions and materials of the active antenna 10 are not limited; those skilled in the art may make suitable adjustments according to system requirements to accommodate operation frequency demands.

In the prior art, performing transmission/reception via switching between multiple antennas is costly and requires more space. Also, conventional designs utilize single plane structures, which limit utilizable space, and reduce design flexibility. Comparatively, the active antenna 10 of the invention controls the active switch circuit 106 to be coupled to suitable feeding points in the radiator 102 according to the communication status, thus increasing antenna operation bandwidth and enhancing communication quality. Moreover, the three-dimensional structure helps improve space utilization, and thus allows for smaller dimensions.

In summary, the active antenna of the present invention has a wider range of operation bandwidth and smaller dimensions.

Those skilled in the art will readily observe that numerous modifications and alterations of the device and method may be made while retaining the teachings of the invention. Accordingly, the above disclosure should be construed as limited only by the metes and bounds of the appended claims. cm What is claimed is:

1. An active antenna with a wide bandwidth coverage, comprising:
a radiator, comprising at least two feeding points, corresponding to at least two modes, respectively;
a switch control circuit, for generating a switch control signal; and
an active switch circuit, for switching to be coupled to one of the at least two feeding points according to the switch control signal.

2. The active antenna of claim 1 further comprising a signal feeding terminal, for feeding a radio-frequency signal into to one of the at least two feeding points via the active switch circuit.

3. The active antenna of claim 2, wherein the signal feeding terminal is a coaxial cable signal feeding terminal.

4. The active antenna of claim 1, wherein there is an angle between a first extension plane of the active switch circuit and a second extension plane of the radiator.

5. The active antenna of claim 1, wherein an antenna ground plane of the radiator and a first extension plane of the active switch circuit are disposed on a substrate.

6. The active antenna of claim 1, wherein an antenna ground plane of the radiator is parallel to a first extension plane of the active switch circuit.

7. The active antenna of claim 1, wherein an antenna ground plane of the radiator is an extension of a ground plane of the active switch circuit.

8. An electronic device, comprising:
a radio-frequency processing unit, for processing a radio-frequency signal; and
an active antenna with a wide bandwidth coverage, comprising:
a radiator, comprising at least two feeding points corresponding to at least two modes, respectively;
a switch control circuit, for generating a switch control signal; and
an active switch circuit, for switching to be coupled to the one of the at least two feeding points according to the switch control signal.

9. The electronic device of claim 8, wherein the active antenna further comprises a signal feeding terminal, for feeding the radio-frequency signal into to one of the at least two feeding points via the active switch circuit.

10. The electronic device of claim 9, wherein the signal feeding terminal is a coaxial cable signal feeding terminal.

11. The electronic device of claim 8, wherein there is an angle between a first extension plane of the active switch circuit and a second extension plane the radiator.

12. The electronic device of claim 8, wherein an antenna ground plane of the radiator and a first extension plane of the active switch circuit are disposed on a substrate.

13. The electronic device of claim 8, wherein an antenna ground plane of the radiator is parallel to a first extension plane of the active switch circuit.

14. The electronic device of claim 8, wherein an antenna ground plane of the radiator is an extension of a ground plane of the active switch circuit.
